(19) United States
(12) Patent Application Publication
(10) Pub. No.: US 2024/0082955 A1
(43) Pub. Date: Mar. 14, 2024

(54) METHOD AND SYSTEM FOR LASER BUILD-UP WELDING

(71) Applicant: TRUMPF Laser- und Systemtechnik GmbH, Ditzingen (DE)

(72) Inventors: Bjoern Sautter, Leonberg (DE); Benedikt Wessinger, Kaempfelbach (DE); Marco Opitz, Waldstetten (DE); Andreas Scholz, Taunusstein (DE); Nicolai Speker, Pleidelsheim (DE); Tim Hesse, Ditzingen (DE)

(21) Appl. No.: 18/518,675

(22) Filed: Nov. 24, 2023

Related U.S. Application Data
(63) Continuation of application No. PCT/EP2022/063464, filed on May 18, 2022.

(30) Foreign Application Priority Data
May 27, 2021 (DE) 102021113757.8

(51) Int. Cl. B23K 26/342; B23K 26/70; B23K 31/12

(52) U.S. Cl. CPC B23K 26/342; B23K 26/702; B23K 31/12; B33Y 10/00

(57) ABSTRACT

A method for coating a rotating surface region of a workpiece by laser build-up welding includes fusing a powdery coating material prior to impact on the workpiece in a laser beam that is directed at the surface region, capturing a spatially resolved intensity profile of thermal radiation emitted by the workpiece, comparing at least one property of the intensity profile with at least one predefined target value, and modifying at least one parameter of a coating procedure based on a result of the comparison.

### CROSS REFERENCE TO RELATED APPLICATIONS

This application is a continuation of International Application No. PCT/EP2022/063464 (WO 2022/248311 A1), filed on May 18, 2022, and claims benefit to German Patent Application No. DE 10 2021 113 757.8, filed on May 27, 2021. The aforementioned applications are hereby incorporated by reference herein.

### FIELD

Embodiments of the present invention relate to a method for coating a surface region of a workpiece by laser build-up welding, and to a system for coating a surface region of a workpiece by laser build-up welding.

### BACKGROUND

There is a method known as extreme high-speed laser application (EHLA) welding. Corresponding systems are used to this end.

By virtue of the coating material already being fused in the laser beam, the process speed can be increased significantly vis-à-vis conventional methods of laser build-up welding, in which a laser beam fuses the surface of the workpiece, and the coating material is blown into the melt. Moreover, improved surface properties such as a reduced roughness can be achieved using the EHLA method.

WO 2004/022816 A1 has disclosed a (conventional) method for laser build-up welding. In this method, a laser beam is moved over the surface of a workpiece. The laser beam locally fuses the surface, with the result that a melt pool is obtained. A gas jet is used to blow a powder into the melt pool from a nozzle. An optical signal from the melt pool is acquired and evaluated to determine the temperature of the melt pool. The information from the optical signal is used in a control loop for the purpose of adapting process parameters such as the laser power or the relative speed between the laser beam and the workpiece.

Thermal states may fluctuate in extreme high-speed laser application welding on account of the workpiece geometry. This may affect the quality of the coating. By way of example, reductions in cross section on the workpiece may reduce the heat dissipation, with the result that heat accumulates. This in turn may lead to the formation of pits in the coating. Conversely, an elevated heat dissipation may lead to bonding errors between the material of the workpiece and the coating.

### SUMMARY

Embodiments of the present invention provide a method for coating a rotating surface region of a workpiece by laser build-up welding. The method includes fusing a powdery coating material prior to impact on the workpiece in a laser beam that is directed at the surface region, capturing a spatially resolved intensity profile of thermal radiation emitted by the workpiece, comparing at least one property of the intensity profile with at least one predefined target value, and modifying at least one parameter of a coating procedure based on a result of the comparison.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sketch of a system for coating a rotating workpiece by laser build-up welding according to some embodiments;

FIG. 2a shows a schematic grayscale value representation of an intensity profile of thermal radiation from a coating region during laser build-up welding on a rotating workpiece, without heat accumulation, according to some embodiments;

FIG. 2b shows the intensity profile of FIG. 2a in a schematic three-dimensional representation, according to some embodiments;

FIG. 3a shows a schematic grayscale value representation of an intensity profile of thermal radiation from a coating region during laser build-up welding on a rotating workpiece, while heat accumulates, according to some embodiments;

FIG. 3b shows the intensity profile of FIG. 3a in a schematic three-dimensional representation, according to some embodiments; and

FIG. 4 shows a schematic flowchart of a coating method according to embodiments of the invention.

### DETAILED DESCRIPTION

Embodiments of the invention can improve the process reliability of extreme high-speed laser application welding.

According to some embodiments, a method for coating a rotating surface region of a workpiece by laser build-up welding is provided. The rotation of the workpiece creates a feed in the circumferential direction. The surface region can be an end face, for example of a brake disk. Alternatively, the surface region can be a lateral face, for example of a tube, and in particular of a hydraulic cylinder. In principle, the rotating surface region is at least substantially rotationally symmetric. In particular, internal and external contours of the surface region are rotationally symmetric as a rule. Individual portions of the surface region may break the rotational symmetry. For example, the surface region may have individual holes or the like. The workpiece preferably rotates about an axis of symmetry of the surface region.

In the coating method according to embodiments of the invention, a powdery coating material is fused prior to impact on the workpiece in a laser beam that is directed at the surface region. Consequently, this relates to an extreme high-speed laser application (EHLA) welding method.

A spatially resolved intensity profile of thermal radiation emitted by the workpiece is captured. The thermal radiation is infrared radiation in particular. In principle, the intensity profile is captured in the area of the point of incidence of the laser beam on the surface region. The intensity profile typically comprises a surround of the point of incidence in which the material of the workpiece has not been fused.

At least one property of the intensity profile is compared with at least one predefined target value. At least one characteristic value of the at least one property can be determined to this end. The characteristic value can enable a direct comparison with the target value. The target value characterizes a characteristic of the property of the intensity profile if the coating procedure runs as intended.

At least one parameter of the coating procedure is modified on the basis of a result of the comparison. The at least one parameter of the coating procedure is controlled such that the at least one property of the measured intensity profile approximates the corresponding target value. This improves the quality of the coating on the surface region.

Capturing the intensity profile, comparing the property with the target value, and adapting the parameter are, as a matter of principle, carried out continuously while the coating procedure is performed. Continually performing the aforementioned steps in this respect is also understood as a repeated performance within sufficiently small time intervals, for example at a frequency of at least 100 Hz.

Analyzing the intensity profile makes it possible to monitor the coating procedure. The process reliability is increased by continually adapting the at least one parameter. Moreover, this can allow the coating to be implemented with a constant quality, in particular over the entire surface region and over a plurality of workpieces. Moreover, the closed-loop control of the coating procedure according to embodiments of the invention simplifies the programming and determination of process parameters since disadvantageously chosen initial values of the parameters are corrected automatically. Moreover, this type of process control allows the coating of workpieces which cannot be coated with a sufficient quality using conventional methods, for example because their heat absorptivity varies so significantly within the surface region that respectively different parameters of the coating procedure need to be applied to this end.

The coating method according to embodiments of the invention is preferably carried out with a coating system according to embodiments of the invention, which is described below. The method according to embodiments of the invention may have further features described hereinbelow.

The intensity profile can be captured by a camera, preferably an infrared camera. The use of such a camera simplifies the implementation of the method.

A joint optical unit is preferably provided for the laser beam and the thermal radiation or the camera. The laser beam and the thermal radiation are typically guided through the joint optical unit in different directions. The complexity associated with capturing the intensity profile in the area of the point of incidence of the laser beam can be reduced by the joint optical unit. If the point of incidence of the laser beam is modified by means of the optical unit, for example by tilting or displacing the optical unit, for instance for a feed movement in a lateral direction, then the area captured by the camera is also automatically modified in corresponding fashion. Moreover, an undistorted image can easily be obtained by means of the joint optical unit.

Alternatively, the camera may be directed directly onto the workpiece, obliquely with respect to the laser beam. This may simplify subsequent retrofitting of an existing coating system to perform the method according to embodiments of the invention.

The at least one property of the intensity profile may be selected from the following:
diameter of the intensity profile,
absolute value of the global intensity maximum,
sum of the intensities,
mean value of the intensities, and/or
shape of the intensity profile.

The aforementioned properties can be easily established. Moreover, the inventors have recognized that these properties change significantly in the case of deviations from a target state of the coating process.

The at least one property can be determined by evaluating a cross section of the intensity profile. This simplifies the analysis of the intensity profile.

Preferably, the cross section extends in the circumferential direction of the surface region. The inventors have recognized that the identification of deviations from a target state can be improved as a result thereof.

The cross section may extend offset vis-à-vis a global intensity maximum. Preferably, the cross section is arranged ahead of the global intensity maximum of the intensity profile in the lateral feed direction. Deviations from the target state are clear in a cross section extending thus. The lateral direction corresponds to a radial direction when coating an end face and an axial direction when coating a lateral face.

The property preferably is a characteristic, in particular an absolute value, of a local intensity maximum. This enables a reliable identification of heat accumulation. In the case of an evaluation in a cross section offset vis-à-vis the global intensity maximum, the local intensity maximum appears as a global maximum of the relevant cross section; however, the local intensity maximum is smaller than the global intensity maximum of the overall intensity profile.

The at least one parameter of the coating procedure to be modified may be selected from the following:
laser power,
feed rate in the circumferential direction,
feed rate in the lateral direction,
offset of successive points of incidence of the laser beam in the lateral direction, and/or
mass flux of the coating material.

These parameters enable an effective compensation of temperature-dependent disturbances of the coating procedure.

Advantageously, the coating material emerges from a nozzle that is concentric with the laser beam. This improves the uniformity of the application of the coating material to the workpiece. Optionally, the nozzle may also be concentric with a joint optical unit for the laser beam and a camera. The coating material can be blown through the nozzle by way of a supply device.

The workpiece may have a heat absorptivity that varies in the lateral direction and/or in the circumferential direction. In this context, heat absorptivity means the capability of storing and/or transmitting heat. The advantages of the method according to embodiments of the invention are manifested clearly in the case of such workpieces. The local differences in the heat absorptivity of the workpiece may require different parameters of the coating procedure. Therefore, (high-quality) coating may not be possible under certain circumstances if fixed parameters are used. By contrast, the automatic adaptation of the at least one parameter allows high-quality and cost-effective coating of even such hard-to-coat workpieces. By way of example, the varying heat absorptivity may result from an internal structure of the workpiece; for example, the workpiece may have ventilation channels in the interior thereof. The varying heat absorptivity may manifest itself on the surface; for example, the workpiece may have drilled holes in the surface region to be coated.

Embodiments of the present invention further relate a system for coating a rotating surface region of a workpiece by laser build-up welding.

The system comprises a laser device for directing a laser beam at the surface region. A laser power of the laser device can be at least 2000 W. A wavelength of the laser beam can be at least 800 nm, preferably at least 1000 nm, and/or no more than 2000 nm, preferably no more than 1100 nm.

The system also comprises a nozzle for blowing coating material into the laser beam. The nozzle is preferably arranged concentrically with the laser beam that is directed at the workpiece.

Further, the system comprises a rotary device for rotating the workpiece, in particular about an axis of symmetry of the surface region. A feed in the circumferential direction can be brought about easily by rotating the workpiece by means of the rotary device.

Moreover, the system comprises a camera for recording an intensity profile of thermal radiation emitted by the workpiece. The camera is preferably an infrared camera. Accordingly, the thermal radiation can be infrared radiation. An actual thermal state of the coating procedure can be established by means of the camera.

Finally, the system comprises a closed-loop control device configured to compare at least one property of the intensity profile with at least one predefined target value and modify at least one parameter of a coating procedure depending on a result of the comparison. The closed-loop control device is configured, in particular, to modify the at least one parameter of the coating procedure such that the at least one property of the measured intensity profile approximates the corresponding target value. This improves the quality of the coating on the surface region. The closed-loop control device is typically also configured to establish the at least one property of the intensity profile. Alternatively, the at least one property could be established by means of the camera, for example.

The system, in particular the camera and the closed-loop control device, are in principle configured to continually capture the intensity profile, continually compare the at least one property with the at least one predefined target value, and continually adapt the at least one parameter. Continually performing the aforementioned steps in this respect is also understood as a repeated performance within sufficiently small time intervals, for example at a frequency of at least 100 Hz.

The system according to embodiments of the invention is configured to carry out the above-described method according to embodiments of the invention. The system may be configured to implement further features of the method.

The system may comprise a joint optical unit for the laser device or laser beam and the camera or thermal radiation. The joint optical unit typically allows the laser beam and the thermal radiation to be passed through in different directions. The complexity associated with capturing the intensity profile in the area of the point of incidence of the laser beam can be reduced by the joint optical unit. If the point of incidence of the laser beam is modified by means of the optical unit, for example by tilting or displacing the optical unit, for instance for a feed movement in a lateral direction, then the area captured by the camera is also automatically modified in corresponding fashion. Moreover, an undistorted image can easily be obtained by means of the joint optical unit.

The system may furthermore comprise a storage device for storing at least one value of the intensity profile and/or at least one value of the at least one property. This makes it simpler to analyze and influence the coating procedure. In particular, this may enable a retrospective evaluation, for example for quality control.

Further, the system may comprise a display device for outputting at least one value of the intensity profile, at least one value of the at least one property, at least one value of the at least one parameter, and/or at least one value of a deviation of the at least one parameter from the at least one target value. As an alternative or in addition, the display device may be configured to output an image from the camera. System operators can consequently easily monitor the coating procedure or set up the system.

Further advantages of the embodiments of the invention are evident from the description, the claims, and the drawing. According to embodiments of the invention, the features mentioned above and those still to be further presented can be used in each case individually or together in any desired expedient combinations. The embodiments shown and described should not be understood as an exhaustive list, but rather are of an exemplary character for elucidating the invention.

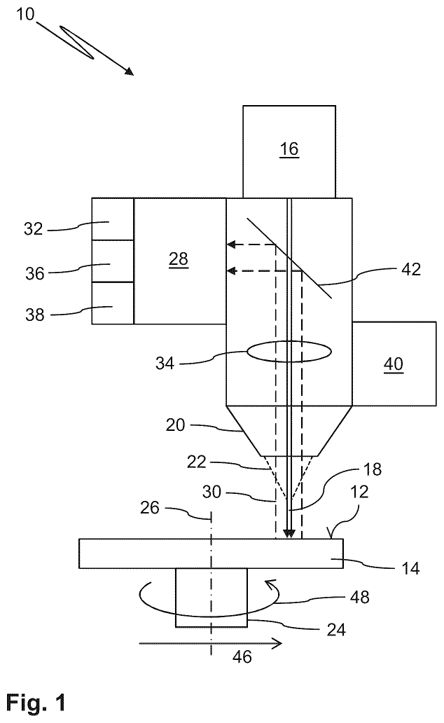

FIG. 1 shows a system 10 for coating a rotating surface region 12 of a workpiece 14 by laser build-up welding. The workpiece 14 can be an internally vented brake disk with interior ventilation channels, for example. In this case, the surface region 12 is located on an end face of the workpiece 14 serving as a friction surface. The intention is to provide the surface region 12 with a wear-reducing coating.

To coat the rotationally symmetric surface region 12, the workpiece 14 is rotated about an axis of symmetry 26 by means of a rotary device 24. The rotational movement brings about a coating procedure feed in the circumferential direction. Moreover, the workpiece can be displaced in the radial direction by means of the rotary device 24, in order to bring about a corresponding feed in the lateral (in this case radial) direction.

The system 10 comprises a laser device 16. The laser device 16 emits a laser beam 18. The laser beam 18 strikes the rotating surface region 12. As a result, the material of the workpiece 14 can be fused locally in the area of the point of incidence of the laser beam 18. Rather than displacing the workpiece 14, the laser device 16 could be displaced in order to bring about the feed in the lateral direction.

A supply device 40 is used to blow a powdery coating material 22 through a nozzle 20 toward the workpiece 14 and into the laser beam 18. It is understood that this is shown only very abstractly in FIG. 1 and in particular not shown true to scale. The nozzle 20 may be arranged concentrically with the laser beam 18. The coating material 22 is fused in the laser beam 18 before striking the workpiece 14. Consequently, this relates to an extreme high-speed laser application welding method. The molten coating material 22 strikes the locally fused material of the workpiece 14 on the surface region 12. The melts of the coating material 22 and the workpiece 14 are bonded to one another and solidify forming a coating when the point of incidence of the laser beam 18 migrates onward on account of the feed movement of the workpiece 14.

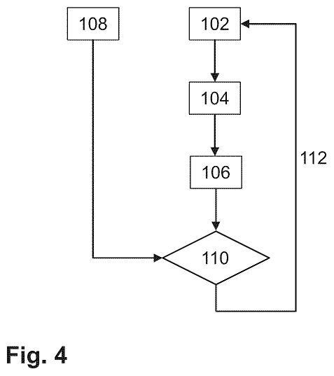

In the flowchart shown in FIG. 4, the above-described coating procedure is represented as step 102. An intensity profile of thermal radiation 30, more particularly infrared radiation, is recorded in a step 104 while the coating procedure 102 is performed, the thermal radiation being emitted by the workpiece 14 in the area of the point of incidence of laser beam 18 and coating material 22. To this end, the system 10 comprises a camera 28, specifically an infrared camera (cf. FIG. 1).

In the illustrated exemplary embodiment, the system 10 comprises a joint optical unit 34 for the laser beam 18 and the camera 28 or the thermal radiation 30 captured by the camera 28. The joint optical unit 34 may comprise a lens or a lens system. A dichroic mirror 42 can allow the laser beam 18 emanating from the laser device 16 to pass to the workpiece 14 and can deflect thermal radiation, which is emitted back from the workpiece 14 in a manner coaxial to the laser beam 18, to the camera 28.

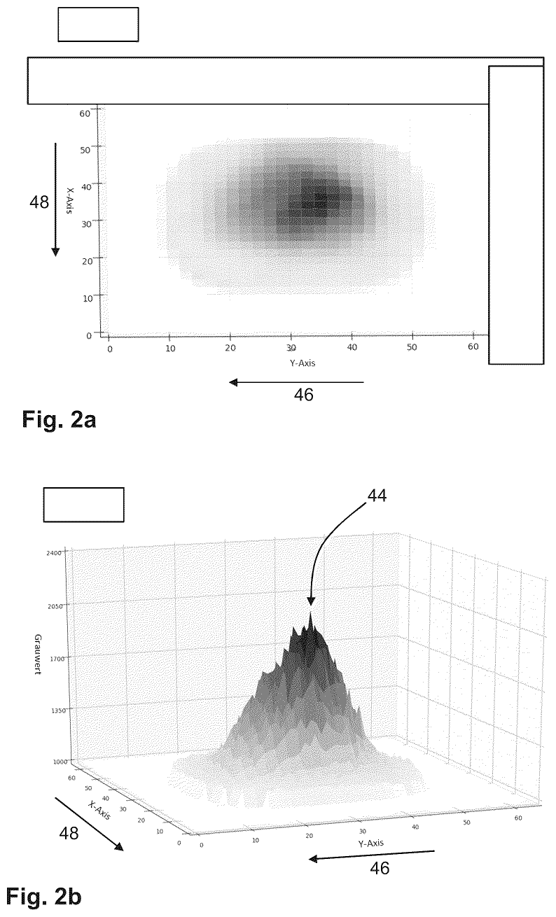

An intensity profile of thermal radiation from the processing zone when the rotating workpiece 14 is coated by a procedure operating as desired is shown in FIGS. 2a and 2b. The intensity profile is similar to a Gaussian profile and has a global maximum 44. On account of the feed movement, the intensity profile is not symmetric but distorted to a certain extent. In this case, the global maximum 44 trails the point of incidence of the laser beam 18 on the workpiece 14 in the lateral feed direction 46. The feed in the circumferential direction is implemented in the direction of the arrow 48.

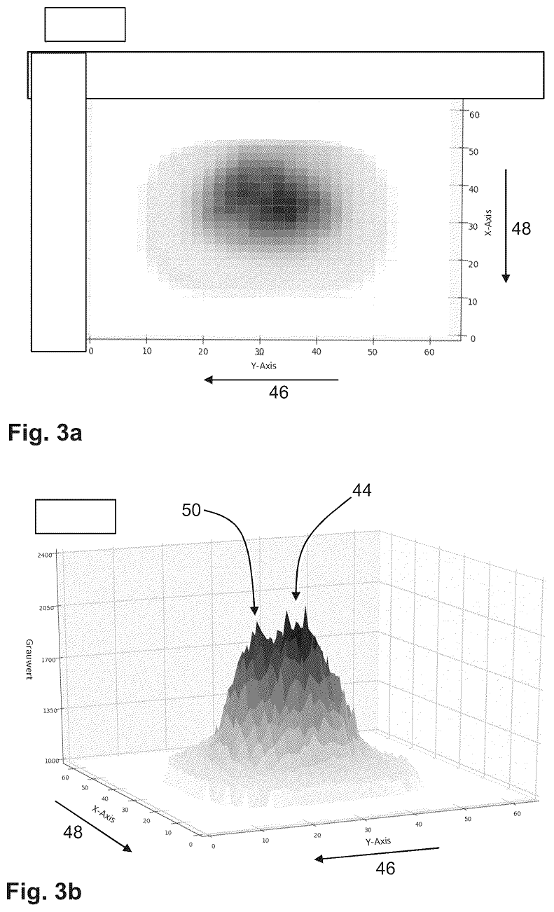

FIGS. 3a and 3b show an intensity profile of thermal radiation if heat accumulates, for example in the region of a ventilation channel, during the coating procedure on the workpiece 14. The shape of the intensity profile changes as a result of the heat accumulation. In particular, the intensity profile has a local maximum 50 in addition to the global maximum 44. The local maximum 50 runs ahead of the global maximum 44 in the lateral feed direction 46 and trails the latter in the tangential feed direction 48. In a cross section through the intensity profile which extends in the circumferential direction (parallel to the tangential feed direction 48) and extends offset vis-à-vis the global maximum 44, to be precise ahead of the global maximum 44 in the lateral feed direction 46, the local maximum 50 appears as a “global maximum”. In this case, the absolute value of the local maximum 50 is smaller than the absolute value of the global maximum 44.

The presence or lack of such a local maximum 50 in a cross section defined relative to the global maximum 44 represents a property of the intensity profile. In particular, the maximum absolute value of the intensity of the thermal radiation in this cross section also describes a property of the intensity profile (the latter corresponds to the absolute value of the local maximum 50, if formed). Further properties of the intensity profile may include for example a diameter of the intensity profile (with respect to a lower threshold value of the intensity), the absolute value of the global intensity maximum 44, a sum of the intensities (integral of the intensities over the area of the intensity profile delimited by the lower threshold value), a mean value of the intensities (within the intensity profile delimited by the lower threshold value), and/or a shape of the intensity profile. At least one characteristic value for one of the aforementioned properties is established in a step 106, cf. FIG. 4.

At least one corresponding target value was defined in a step 108, prior to the start of the coating procedure, for the characteristic of at least one of these properties in a coating procedure operating as desired. The target value and the established property or its characteristic value are compared with one another in a step 110.

At least one parameter of the coating procedure is suitably adapted in a step 112 if the result of the comparison indicates a deviation from the desired progression of the coating procedure, for example on account of heat accumulation or excessive heat dissipation. In the process, the operational sequence of the coating procedure is modified such that the property of the intensity profile approximates its target value. As a result of this, a coating with a better quality is obtained in comparison with the case where the parameters remain unchanged. For example, the parameter to be modified can be a laser power of the laser beam 18, the feed rate in the circumferential direction 48, the feed rate in the lateral direction 46, an offset of successive points of incidence of the laser beam 18 in the lateral direction 46, and/or a mass flux of the coating material 22.

The system 10 comprises a closed-loop control device 32 for performing steps 106, 108, 110, and 112; cf. FIG. 1. The closed-loop control device 32 may be integrated in the camera 28. The system 10 further comprises a storage device 36, which may likewise be integrated in the camera 28. One or more target values, characteristic values of the intensity profile, and/or results of the comparison with the target values can be stored in the storage device 36. A display device 38 may also be connected to, or integrated in, the camera 28. The display device 38 makes it possible to display an image recorded by the camera 28 in order to be able to adapt camera settings, for example regarding exposure, focusing, size of the image portion, etc.

Thus, embodiments of the invention relate to an extreme high-speed laser application welding method. A workpiece is rotated such that a substantially rotationally symmetric surface region is coated. Thermal characteristic values of the ongoing coating procedure are established from a thermal image and are compared with target values. Suboptimal coating conditions, for example on account of a locally deviating thermal absorptivity of the workpiece, are able to be identified on the basis of the comparison and are corrected accordingly where necessary.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

System 10
Surface region 12
Workpiece 14
Laser device 16
Laser beam 18
Nozzle 20
Coating material 22
Rotary device 24
Axis of symmetry 26
Camera 28
Thermal radiation 30
Closed-loop control device 32
Optical unit 34
Storage device 36
Display device 38
Supply device 40
Dichroic mirror 42
Global maximum 44
Lateral feed direction 46
Tangential feed direction 48
Local maximum 50
Coating by laser build-up welding 102
Recording 104 an intensity profile
Establishing 106 a characteristic value of a property
Predefining 108 a target value
Comparing 110
Modifying 112

1. A method for coating a rotating surface region of a workpiece by laser build-up welding, the method comprising:
fusing a powdery coating material prior to impact on the workpiece in a laser beam that is directed at the surface region,
capturing a spatially resolved intensity profile of thermal radiation emitted by the workpiece,
comparing at least one property of the intensity profile with at least one predefined target value, and
modifying at least one parameter of a coating procedure based on a result of the comparison.

2. The method as claimed in claim 1, wherein the intensity profile is captured using an infrared camera.

3. The method as claimed in claim 1, wherein a joint optical unit is provided for the laser beam and the thermal radiation.

4. The method as claimed in claim 1, wherein the at least one property of the intensity profile is one of:
a diameter of the intensity profile,
an absolute value of a global intensity maximum,
a sum of the intensities,
a mean value of the intensities, or
a shape of the intensity profile.

5. The method as claimed in claim 1, wherein the at least one property is determined by evaluating a cross section of the intensity profile.

6. The method as claimed in claim 5, wherein the cross section extends in a circumferential direction of the surface region.

7. The method as claimed in claim 5, wherein the cross section extends offset from a global intensity maximum.

8. The method as claimed in claim 7, wherein the cross section extends ahead of the global intensity maximum in a lateral feed direction.

9. The method as claimed in claim 1, wherein the property is an absolute value of a local intensity maximum.

10. The method as claimed in claim 1, wherein the at least one parameter of the coating procedure is one of:
a laser power,
a feed rate in a circumferential direction,
a feed rate in a lateral direction,
an offset of successive points of incidence of the laser beam in the lateral direction, or
a mass flux of the coating material.

11. The method as claimed in claim 1, wherein the coating material emerges from a nozzle that is concentric with the laser beam.

12. The method as claimed in claim 1, wherein the workpiece has a heat absorptivity that varies in a lateral direction and/or in a circumferential direction.

13. A system for coating a rotating surface region of a workpiece by laser build-up welding, the system comprising
a laser device for directing a laser beam at the surface region,
a nozzle for blowing a coating material into the laser beam,
a rotary device for rotating the workpiece,
an infrared camera for recording an intensity profile of thermal radiation emitted by the workpiece, and
a closed-loop control device configured to compare at least one property of the intensity profile with at least one predefined target value, and modify at least one parameter of a coating procedure based on a result of the comparison.

14. The system as claimed in claim 13, further comprising a joint optical unit for the laser device and the camera.

15. The system as claimed in claim 13, further comprising a storage device for storing at least one value of the intensity profile and/or of the at least one property.

16. The system as claimed in claim 13, further comprising a display device for outputting at least one value of the intensity profile, and/or the at least one property, and/or the at least one parameter, and/or a deviation of the at least one property from the at least one predefined target value, and/or for displaying an image from the infrared camera.
